(19) United States
(12) Patent Application Publication
(10) Pub. No.: US 2005/0136226 A1
(43) Pub. Date: Jun. 23, 2005

(54) Luminous pattern on surface of fundamental material

(76) Inventors: Tsui Wan Chen, XingZhuang City (TW); Haw Liang Tang, SanChong City (TW)

Correspondence Address: PRO-TECHTOR INTERNATIONAL, 20775 Norada Court, Saratoga, CA, 95070-3018, US

(21) Appl. No.: 10/740,246

(22) Filed: Dec. 17, 2003

(51) Int. Cl. B32B 3/00

(52) U.S. Cl. 428/195.1; 428/690

(57) ABSTRACT

The luminous pattern on surface of fundamental material comprises: a fundamental material; a color-pattern layer on the surface of the fundamental material; a first noctilucent layer on the color-pattern layer; a second noctilucent layer on the color-pattern layer. The pattern will perform the effect of a color pattern in daytime and a luminous pattern in nighttime.

### BACKGROUND OF THE INVENTION

1. Field of the Invention

This invention relates generally to a luminous pattern on the surface of a fundamental material, or it relates specifically to a multi-color or colorful pattern formation with noctilucent effect formed on the surface of a fundamental material applied on a conventional lampshade, picture frame, clock panel, religious article, stationery, pen container, etc.

2. The Prior Arts

In our daily lives, we can see the lampshade, picture frame, clock, religious article, pen container, etc., almost everywhere, and we'll find out that those things are usually accompanied with respective symbolical patterns or words or relief designs to attract possible consumers. A recent skill is to paint or print a monochromatic or colorful pattern, or a wood-grained or stone-grained imitation on the surface of a horn-type lampshade, frame panel, clock panel, religious article, stationery, or pen container.

The articles mentioned look sound splendid if they are duly arranged in a parlor or room, however, they would become eclipsed in a dark environment, and the worst part is that they might be bumped to drop on the floor. Nevertheless, a night lamp is not suggested during sleeping because of a possible bad affect to kid's eyes according to a medical report.

Besides, though the clock available in market can show its figures on the panel thereof in nighttime, in reality, this is done by means of coating the figures with a fluorescent agent in advance, which is supposed to absorb external light in day time and release the light in dark in a limited period before the color is faded away thoroughly.

### SUMMARY OF THE INVENTION

The primary object of this invention is to provide a luminous pattern on surface of fundamental material by printing with a luminous ink on a lamp shade, picture frame, clock, religious article, stationery, pen container, etc. The luminous ink is made from a rare-earth-element-activated nontoxic and nonradiative alkaline earth aluminate that doesn't do any harm to human beings as compared with a conventional fluorescent agent, and is durable to last 4˜6 hrs. The printed luminous pattern will perform a luminous multi-color or color effect in addition to its illuminating function that can prevent people from be bumped.

In order to realize the mentioned object, the luminous pattern on surface of fundamental material comprises: a fundamental material; a color-pattern layer on the surface of the fundamental material; a first noctilucent layer on the color-pattern layer; a second noctilucent layer on the color-pattern layer. The pattern will perform the effect of a color pattern in daytime and a luminous pattern in nighttime.

For more detailed information regarding advantages or features of this invention, at least an example of preferred embodiment will be described below with reference to the annexed drawings.

### BRIEF DESCRIPTION OF THE DRAWINGS

The related drawings in connection with the detailed description of this invention to be made later are described briefly as follows, in which:

FIGS. 1˜3 are schematic views showing the procedure for printing a luminous pattern of this invention on the surface of a fundamental material;

FIG. 4 is a schematic view showing a printed luminous pattern of this invention; and

FIG. 5 shows another embodiment of this invention.

Enclosure is a picture of lampshade with noctilucent effect in the dark.

### DETAILED DESCRIPTION OF THE PREFERRED EMBODIMENT

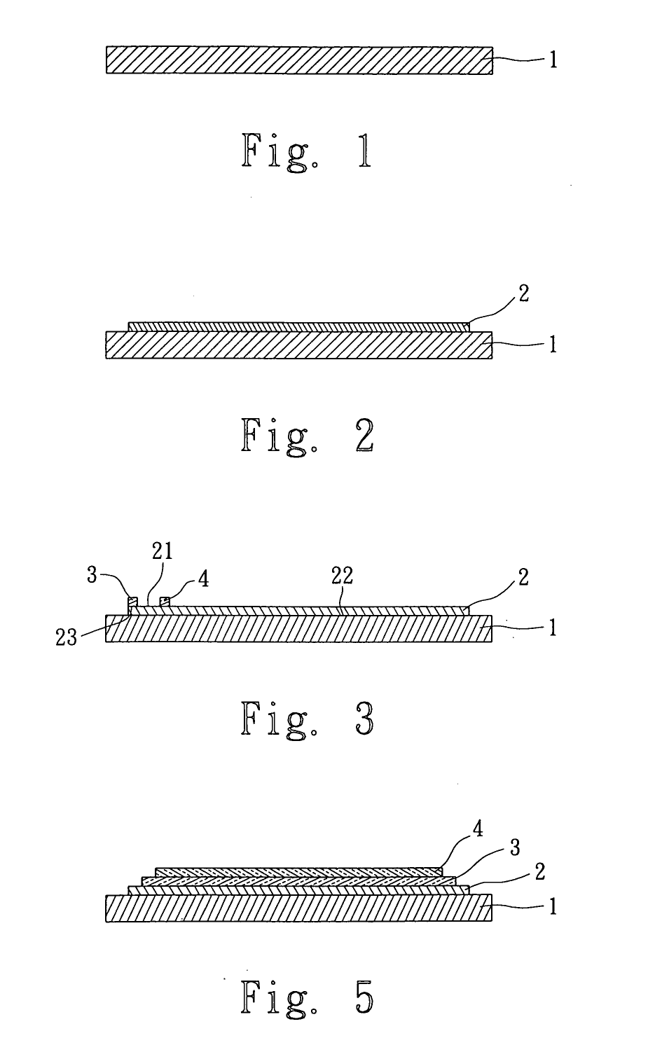

FIGS. 1˜3 are schematic views showing the procedure for printing a luminous pattern of this invention on the surface of a fundamental material (1). As shown in the figures, after a luminous pattern has been formed on the surface of the fundamental material (1), the luminous pattern is supposed to absorb the incident energy of a light source. When the light source (not shown) is turned off or the luminous pattern is moved to a dark place, the luminous pattern would serve for a light source in different colors to perform a multi-color or colorful luminous effect, and the luminous ink applied is a durative chemical for lasting about 4 to 6 hrs.

In printing the luminous ink, the procedure is to first choose the fundamental material (1), which could be any of paper, PVC, or cloth used for light fixture, picture frame, clock, religious article, stationery, or pen container, etc., then, proceed a corona treatment to the skin of the fundamental material (1), in which the corona treatment is a treatment of electric shock using high voltage and cycle to treat the skin pores of the fundamental material (1) to enhance the adhering force thereof. After this, the skin of the fundamental material (1) is printed with a color ink to form a color-pattern layer (2), which is then coated with a micro-glue and printed with a luminous ink at this time. The luminous ink, preferably made from a rare-earth-element-activated nontoxic and nonradiative alkaline earth aluminate, which doesn't do any harm to human beings as compared with a conventional fluorescent agent, is printed at least on a partial surface portion (21) or a relatively larger surface portion (22) or a peripheral portion of profile lines (23) to form a first noctilucent layer (3).

After the first noctilucent layer (3) is completed, it is then printed with a luminous ink doped with a fixing agent to form a second noctilucent layer (4), in which no more treatment is required for the surface of the first noctilucent layer (3), and the fixing agent added is to strengthen the first and the second layers (3, 4) and flatten the surfaces thereof. Nevertheless, in printing the second noctilucent layer (4), the luminous ink is also applied to the same color-pattern layer (2) on the partial surface portion (21) or the relatively larger surface portion (22) or the peripheral portion of profile lines (23) to outstandingly show the difference between the noctilucent layers (3, 4).

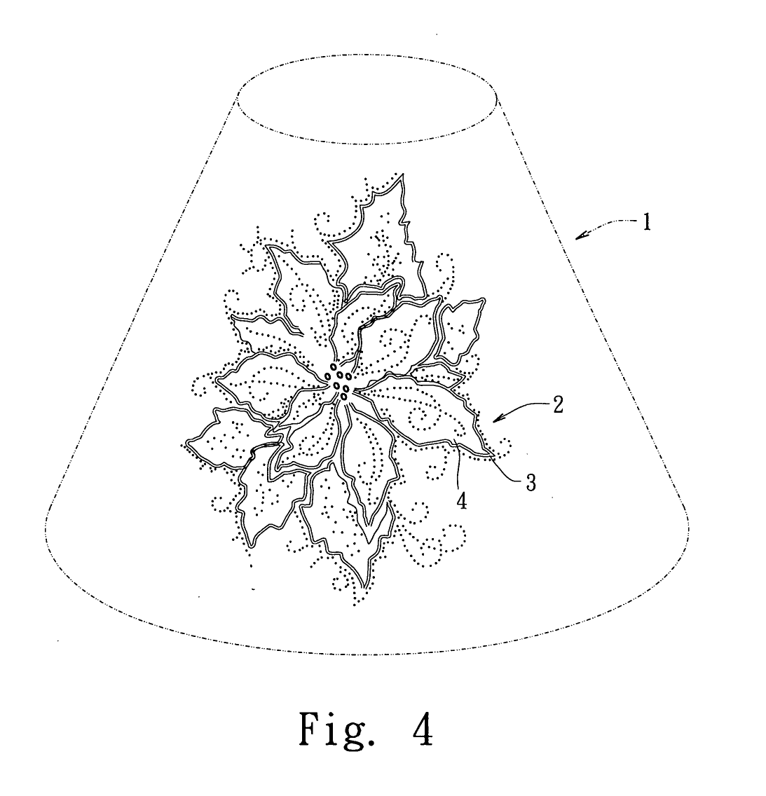

FIGS. 3 and 4 show the procedure for printing a luminous pattern of this invention on the surface of a fundamental material and the luminous effect presented after printing. As shown in the figures, the first noctilucent layer (3) is printed along a peripheral portion of leaf's profile lines (23) while the second noctilucent layer (4) on the larger surface portion (22) of the leaf blade to thereby create a colorful luminous effect when rays are incident upon the leaf.

However, after absorption of light in a certain period and shutdown of the light source, in the event both the noctilucent layers (3, 4) on the color-pattern layer (2) are printed in the same color, the profile of the color-pattern layer (2) is emerged (as shown in the enclosed picture); or a multi-color or colorful luminous effect is presented suppose the noctilucent layers (3, 4) are different in color.

We would refer you this time to FIG. 5—another embodiment of this invention. As shown in FIG. 5, in addition to creating different colors and spectra, the first and the second noctilucent layers (3, 4) could be overlapped on each other to produce different spectra to display what people would regard them as different luminous colors.

A “contrast” efficacy is obtainable by the first and the second noctilucent layers (3, 4) themselves, while it is controllable by the thickness of printed layers through a printing machine.

Moreover, different luminous colors could also be displayed when the noctilucent layers (3, 4) in different thickness are overlapped with each other.

Yet, different refraction phenomena may occur owing to different fundamental materials. For example, a multi-scattering phenomenon is attainable by using a frosted glass.

Yet, besides the common inks for color printing, a thermal-sensitive and color changeable ink which is supposed to change its color whenever a thermal change is sensed, in which a color-display agent and an electronic reaction catalyst are buried in a micro-capsule by means of the micro-capsule technology.

Yet, the mentioned techniques of this invention could be applied to a lampshade, picture frame, cartoon clock panel, religious articles, stationery and pen container, etc.

In the above described, at least one preferred embodiment has been described in detail with reference to the drawings annexed, and it is apparent that numerous changes or modifications may be made without departing from the true spirit and scope thereof, as set forth in the claims below.

1. A luminous pattern on surface of fundamental material for performing a multi-color or colorful luminous effect, comprising:
a fundamental material;
a color-pattern layer on said fundamental material;
a first luminous layer on said color-pattern layer; and
a second luminous layer on said color-pattern layer; whereby said pattern will perform a multi-color or colorful effect during daytime, or a luminous effect during nighttime.

2. The luminous pattern according to claim 1, in which said fundamental material is any of paper, PVC, or cloth.

3. The luminous pattern according to claim 1, in which said first luminous layer is disposed on said color-pattern layer at more than any of a partial surface portion, a larger surface portion, or a peripheral portion of profile lines.

4. The luminous pattern according to claim 1, in which said second luminous layer is disposed on said color-pattern layer at more than any of a partial surface portion, a larger surface portion, or a peripheral portion of profile lines.

5. The luminous pattern according to claim 1, in which said first and said second luminous layer are spectra in a same color.

6. The luminous pattern according to claim 1, in which said first and said second luminous layer are spectra in different colors.

7. The luminous pattern according to claim 1, in which said first and said second luminous layer are printed one on top of another.

8. The luminous pattern according to claim 1, in which the thickness of said first and said second luminous layer are controlled by a printing machine.

9. The luminous pattern according to claim 1, in which the color ink applied for said color-pattern layer is any of an average ink for color print or a thermal-sensitive color changeable ink.
